(19) United States
(12) Patent Application Publication
(10) Pub. No.: US 2026/0050309 A1
(43) Pub. Date: Feb. 19, 2026

(54) METHOD AND DEVICE FOR POWER EFFICIENCY REPORTING AND DYNAMIC POWER PROFILE ADJUSTMENT

(71) Applicant: Samsung Electronics Co., Ltd, Gyeonggi-do (KR)

(72) Inventors: Nicole Danielle ROSS, Folsom, CA (US); Daniel Lee Helmick, Erie, CO (US)

(21) Appl. No.: 19/285,801

(22) Filed: Jul. 30, 2025

Related U.S. Application Data
(60) Provisional application No. 63/682,688, filed on Aug. 13, 2024.

(51) Int. Cl. G06F 1/26

(52) U.S. Cl. CPC G06F 1/26

(57) ABSTRACT

Methods and devices are provided in which a device captures power consumption and device performance for a workload at the device. The device determines power efficiency for the workload based on the power consumption and the device performance. The device reports the power efficiency for the workload to a host.

### PRIORITY

This application is based on and claims priority under 35 U.S.C. § 119(e) to U.S. Provisional Patent Application Ser. No. 63/682,688, filed on Aug. 13, 2024, the entire contents of which are incorporated herein by reference.

### TECHNICAL AREA

The present disclosure relates generally to drive sustainability, and more particularly, to a method for power efficiency reporting and dynamic power profile adjustment.

### BACKGROUND

The present background section is intended to provide context only, and the disclosure of any concept in this section does not constitute an admission that said concept is prior art.

The rapid advancement of technology and the global push for sustainability have highlighted the need for efficient power management in electronic systems. As data processing demands grow, systems are designed to handle higher interface speeds and increased workloads, resulting in greater energy consumption. While improvements in performance are crucial, the environmental impact of such systems is becoming a major concern for both manufacturers and end-users. Devices that optimize performance per power (watt) are more desirable, as they align with the goals of reducing total cost of ownership (TCO) and minimizing environmental impact.

Traditionally, power consumption has been reported as a singular, static metric that represents the overall power usage of a device or system. While straightforward, this method fails to capture the dynamic nature of modern workloads. For instance, parameters such as queue depth (QD) and command sizes vary significantly during operation, impacting power efficiency in ways that a static metric cannot fully reflect. Furthermore, as companies adopt climate science-based goals to meet sustainability targets, the lack of standardized and relevant metrics hampers their ability to identify actionable steps for reducing greenhouse gas emissions and improving overall efficiency.

### SUMMARY

According to an embodiment, a method is provided in which a device captures power consumption and device performance for a workload at the device. The device determines power efficiency for the workload based on the power consumption and the device performance. The device reports the power efficiency for the workload to a host.

According to this embodiment, the device may log power efficiency over time, and may report, to the host, power consumption values or an average power consumption over a time period for the workload. The device may report power profiles to the host. The power profiles include internal settings of the device that increase power efficiency for different workload scenarios. The device may receive, from the host, a power profile selected by the host from among the power profiles. The device may adjust the internal settings for resource utilization at the device based on the selected power profile.

According to this embodiment, the device may receive, from the host, workloads assigned by the host based on the reported power efficiency.

According to this embodiment, the device may determine that a current power profile of the device has deficient power efficiency for the workload. The device may provide, to the host, a notification of the deficient power efficiency for the workload. The device may select a new power profile for the device that increases power efficiency for the workload. The device may autonomously enter the new power profile. Alternatively, the device may report the new power profile to the host.

According to this embodiment, the device may adjust internal settings of the device to increase power efficiency based on previous usage patterns at the device.

According to an embodiment, a method is provided in which a host receives power efficiency for a workload at a device, from the device. The power efficiency is based on power consumption and device performance. The host determines that the power efficiency is deficient for the workload. The host transmits, to the device, an update to the device that increases power efficiency at the device.

According to this embodiment, the host may receive, from the device, power consumption values or an average power consumption over a time period for the workload. According to this embodiment, the host may receive power profiles of the device from the device. The power profiles include internal settings of the device that increase power efficiency for different workload scenarios. The host may select a power profile, from the among the power profiles, that increases power efficiency for the workload at the device. Transmitting the update may include transmitting the selected power profile to the device. The device may adjust the internal settings for resource utilization at the device based on the selected power profile.

According to this embodiment, selecting the power profile may include setting an initial power profile, from among the power profiles, and monitoring power efficiency at the device based on the initial power profile. The setting and monitoring may be repeated for one or more other profiles, from among the power profiles. The selected power profile has a highest power efficiency for the workload among the monitored power profiles.

According to this embodiment, the host may select workloads for the device based on the reported power efficiency. Transmitting the update may include transmitting the selected workloads to the device.

According to this embodiment, the host may receive, from the device, a notification of deficient power efficiency for the workload at the device. The host may receive a new power profile from the device. The new power profile increases power efficiency for the workload at the device.

According to an embodiment an electronic device is provided that includes a processor and a non-transitory computer readable storage medium storing instructions. When executed, the instructions cause the processor to capture power consumption and performance for a workload, determine power efficiency for the workload based on the power consumption and the performance, and report the power efficiency for the workload to a host.

According to an embodiment, an electronic device is provided that includes a processor and a non-transitory computer readable storage medium storing instructions. When executed, the instructions cause the processor to receive power efficiency for a workload at a device, from the device. The power efficiency is based on power consumption and device performance. The instructions also cause the processor to determine that the power efficiency is deficient for the workload, and transmit, to the device, an update to the device that increases power efficiency at the device.

### BRIEF DESCRIPTION OF THE DRAWINGS

The drawings described below are examples of how embodiments of the disclosure may be implemented, and are not intended to limit embodiments of the disclosure. Individual embodiments of the disclosure may include elements not shown in particular figures and/or may omit elements shown in particular figures. The drawings are intended to provide illustration and may not be to scale. The above and other aspects, features, and advantages of certain embodiments of the present disclosure will be more apparent from the following detailed description, taken in conjunction with the accompanying drawings, in which:

FIG. 1 is a diagram illustrating a data storage management system for processing commands in an electronic device, according to an embodiment;

FIG. 2A is a flowchart illustrating a method for power profile reporting, according to an embodiment;

FIG. 2B is a flowchart illustrating a method for power efficiency reporting, according to an embodiment;

FIG. 3 is a flowchart illustrating a method for power efficiency optimization by a host, according to an embodiment;

FIG. 4 is a flowchart illustrating a method for determining power profile misuse, according to an embodiment;

FIG. 5 is a flowchart illustrating a method for recording average performance and power over time, according to an embodiment;

FIG. 6 is a block diagram of an electronic device in a network environment for processing commands, according to an embodiment.

### DETAILED DESCRIPTION

Hereinafter, embodiments of the present disclosure are described in detail with reference to the accompanying drawings. It should be noted that the same elements will be designated by the same reference numerals although they are shown in different drawings. In the following description, specific details such as detailed configurations and components are merely provided to assist with the overall understanding of the embodiments of the present disclosure. Therefore, it should be apparent to those skilled in the art that various changes and modifications of the embodiments described herein may be made without departing from the scope of the present disclosure. In addition, descriptions of well-known functions and constructions are omitted for clarity and conciseness. The terms described below are terms defined in consideration of the functions in the present disclosure, and may be different according to users, intentions of the users, or customs. Therefore, the definitions of the terms should be determined based on the contents throughout this specification.

The present disclosure may have various modifications and various embodiments, among which embodiments are described below in detail with reference to the accompanying drawings. However, it should be understood that the present disclosure is not limited to the embodiments, but includes all modifications, equivalents, and alternatives within the scope of the present disclosure.

Although the terms including an ordinal number such as first, second, etc. may be used for describing various elements, the structural elements are not restricted by the terms. The terms are only used to distinguish one element from another element. For example, without departing from the scope of the present disclosure, a first structural element may be referred to as a second structural element. Similarly, the second structural element may also be referred to as the first structural element. As used herein, the term “and/or” includes any and all combinations of one or more associated items.

The terms used herein are merely used to describe various embodiments of the present disclosure but are not intended to limit the present disclosure. Singular forms are intended to include plural forms unless the context clearly indicates otherwise. In the present disclosure, it should be understood that the terms “include” or “have” indicate existence of a feature, a number, a step, an operation, a structural element, parts, or a combination thereof, and do not exclude the existence or probability of the addition of one or more other features, numerals, steps, operations, structural elements, parts, or combinations thereof.

Unless defined differently, all terms used herein have the same meanings as those understood by a person skilled in the art to which the present disclosure belongs. Terms such as those defined in a generally used dictionary are to be interpreted to have the same meanings as the contextual meanings in the relevant field of art, and are not to be interpreted to have ideal or excessively formal meanings unless clearly defined in the present disclosure.

The terms used in the present disclosure are not intended to limit the present disclosure but are intended to include various changes, equivalents, or replacements for a corresponding embodiment. With regard to the descriptions of the accompanying drawings, similar reference numerals may be used to refer to similar or related elements. A singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, terms such as “1^{st},” “2^{nd},” “first,” and “second” may be used to distinguish a corresponding component from another component, but are not intended to limit the components in other aspects (e.g., importance or order). It is intended that if an element (e.g., a first element) is referred to, with or without the term “operatively” or “communicatively”, as “coupled with,” “coupled to,” “connected with,” or “connected to” another element (e.g., a second element), it indicates that the element may be coupled with the other element directly (e.g., wired), wirelessly, or via a third element.

As used herein, the term “module” may include a unit implemented in hardware, software, firmware, or combination thereof, and may interchangeably be used with other terms, for example, “logic,” “logic block,” “part,” and “circuitry.” A module may be a single integral component, or a minimum unit or part thereof, adapted to perform one or more functions. For example, according to one embodiment, a module may be implemented in a form of an application-specific integrated circuit (ASIC), a co-processor, or field programmable gate arrays (FPGAs).

An electronic device, according to one embodiment, may be one of various types of electronic devices utilizing storage devices (e.g., memory devices). The electronic device may use any suitable storage standard, such as, for example, peripheral component interconnect express (PCIc), nonvolatile memory express (NVMe), NVMe-over-fabric (NVMeoF), advanced extensible interface (AXI), ultra path interconnect (UPI), ethernet, transmission control protocol/Internet protocol (TCP/IP), remote direct memory access (RDMA), RDMA over converged ethernet (ROCE), fibre channel (FC), infiniband (IB), serial advanced technology attachment (SATA), small computer systems interface (SCSI), serial attached SCSI (SAS), Internet wide-area RDMA protocol (iWARP), and/or the like, or any combination thereof. In some embodiments, an interconnect interface may be implemented with one or more memory semantic and/or memory coherent interfaces and/or protocols including one or more compute express link (CXL) protocols such as CXL.mem, CXL.io, and/or CXL.cache, Gen-Z, coherent accelerator processor interface (CAPI), cache coherent interconnect for accelerators (CCIX), and/or the like, or any combination thereof. Any of the memory devices may be implemented with one or more of any type of memory device interface including double data rate (DDR), DDR2, DDR3, DDR4, DDR5, low-power DDR (LPDDRX), open memory interface (OMI), Nvlink high bandwidth memory (HBM), HBM2, HBM3, and/or the like. The electronic devices may include, for example, a portable communication device (e.g., a smart phone), a computer, a portable multimedia device, a portable medical device, a camera, a wearable device, or a home appliance. However, an electronic device is not limited to those described above.

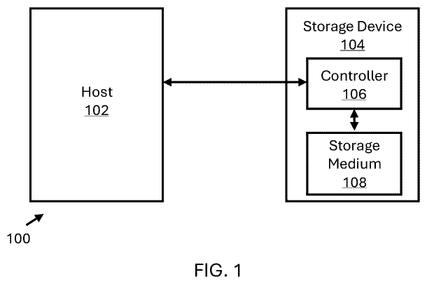

FIG. 1 is a diagram illustrating a data storage management system for processing commands in an electronic device, according to an embodiment. In data storage management, commands may be issued by a host and carried out in a data storage device.

A storage system 100 includes a host 102 and a storage device 104 (e.g., a memory device). Although one host and one storage device are depicted, the storage system 100 may include multiple hosts and/or multiple storage devices. The storage device 104 may be a solid state drive (SSD), a universal flash storage (UFS), etc. The storage device 104 may include a controller 106 and a storage medium 108 connected to the controller 106. The controller 106 may be an SSD controller, a UFS controller, etc. The storage medium 108 may include a volatile memory, a non-volatile memory, or both, and may include one or more flash memory chips (or other storage media). The controller 106 may include one or more processors, one or more error correction circuits, one or more FPGAs, one or more host interfaces, one or more flash bus interfaces, etc., or a combination thereof. The controller 106 may be configured to facilitate transfer of data/commands between the host 102 and the storage medium 108. The host 102 sends data/commands to the storage device 104 to be received by the controller 106 and processed in conjunction with the storage medium 108.

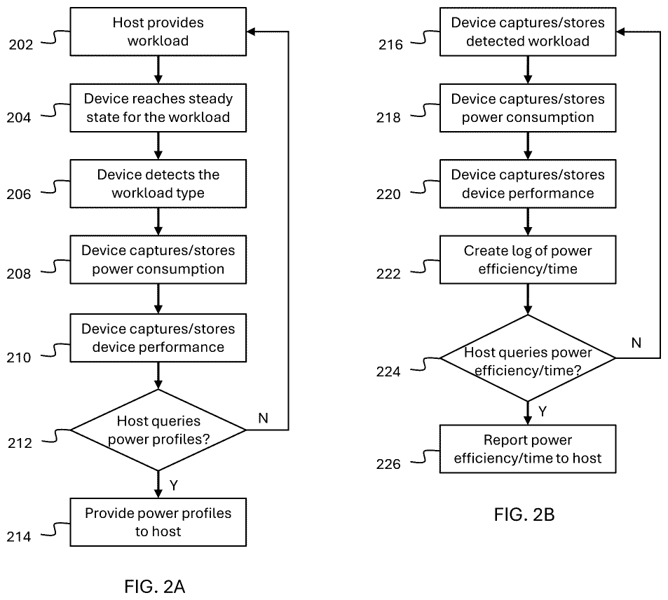

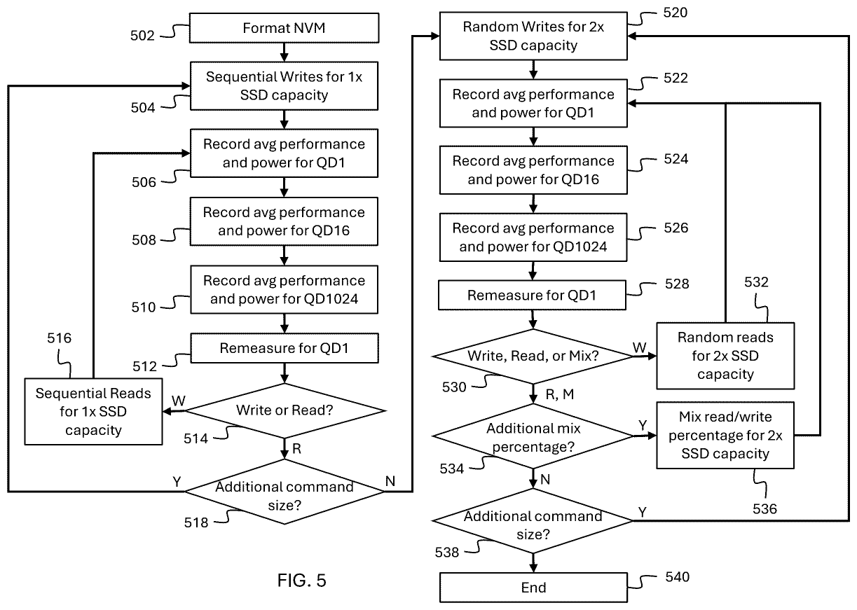

FIG. 2A is a flowchart illustrating a method for power profile reporting, according to an embodiment. At 202, a host may provide a workload to a device. For example, the host 102 may provide the workload to the storage device 104. The workload may include a predefined sequence of read and/or write commands, issued at specific QDs and command sizes. For example, the host may provide a constant workload. At 204, the device may reach a steady state for the workload. For example, the controller 106 may determine that the storage device 104 has reached a steady state for the workload. Reaching a steady state may mean that the device's power consumption and performance metrics have stabilized. At 206, the device may detect a type of the workload. For example, the controller 106 may detect a type of the workload. The host may indicate the type of workload to the device, or the device may determine the type of workload on its own. The device may use internal heuristics or workload classification logic (e.g., analyzing input/output (I/O) patterns such as random versus sequential access, read/write ratio, and QD distribution) to identify the workload type. At 208, the device may capture and store instantaneous power consumption (e.g., both instantaneous and trailing power consumption). For example, the controller 106 may capture and store instantaneous power consumption. This may be accomplished using internal power sensors or firmware counters that track power draw over a specific duration or I/O count. At 210, the device may capture and store instantaneous device performance. For example, the controller 106 may store instantaneous device performance. This may include measuring throughput, e.g., megabytes per second (MB/s), I/O operations per second (IOPS), latency, or other performance indicators corresponding to the workload. These metrics may be captured via firmware monitoring routines and stored in the device's memory. An example of capturing and storing device performance with respect to write and read commands is described in detail below with respect to FIG. 5.

At 212, it is determined whether the host queries the device for power profiles. For example, at 212, it may be determined if the host 102 has queried the storage device 104 for power profiles. If the host has not queried the device for power profiles, the methodology returns to 202. If the host has queried the device for power profiles, the device may provide a set of power profiles to the host for the host to select from, at 214. The host query may occur via an NVMe command. The device may respond by transmitting a list of supported profiles, each associated with a set of adjustable parameters and expected performance/power efficiency metrics under corresponding workload conditions.

The power profiles may be a definition of specific internal settings that a device can set for power efficiency optimization in a specific workload scenario. For example, a first profile may optimize power efficiency of a memory device for low QD reads, a second profile may optimize power efficiency of a memory device for high QD reads, a third profile may optimize power efficiency of a memory device for sequential writes, and a fourth profile may optimize power efficiency of a memory device for random writes. Embodiments are not limited these specific profiles. Settings that enable specific optimizations are described in greater detail below.

FIG. 2A may be performed during device manufacture or before the device ships. The power profiles may be stored permanently from one or more sample drives rather than measured on every device. The power profiles may or may not be remeasured or updated through the life of the device. Updates to the power profiles may be performed without explicitly reaching steady state of a given workload. For example, the device may detect that a workload is occurring and one or more values may be updated. The storage of the power consumption and/or the device performance may be performed at the device and/or the host. The power profiles may be assembled by the device or the host for usage in all manufactured devices.

FIG. 2B is a flowchart illustrating a method for power efficiency reporting, according to an embodiment. At 216, a device may capture and store a detected workload. For example, the controller 106 may detect and classify the workload. This may involve classifying the current activity on the device based on access patterns, such as read versus write ratios, randomness, QD, and command size, using device-level heuristics or workload identification logic. At 218, the device may capture and store instantaneous power consumption (e.g., both instantaneous and trailing power consumption). For example, the controller 106 may capture power usage during workload execution. This may be done using power monitoring circuitry, such as voltage and current sensors or firmware-level energy counters, which sample power usage and store the data in telemetry logs or registers. At 220, the device may capture and store instantaneous device performance (e.g., instantaneous and trailing device performance). For example, the controller 106 may capture and store instantaneous device performance. An example of capturing and storing device performance with respect to write and read commands is described in detail below with respect to FIG. 5. Device performance data may include metrics such as IOPS, throughput (e.g., MB/s), latency, and QD behavior, and may be collected using firmware counters, diagnostic modules, or controller performance monitors.

At 222, the device may create a log (e.g., container-based application management telemetry or unique log) that reports power efficiency over time in terms of performance/power (watt) or power/performance. For example, the controller 106 may generate a time-correlated log of performance and power data stored in memory. This log may contain time-stamped entries that correlate workload characteristics, power readings, and performance metrics to build a profile of device efficiency over various usage patterns. The log may be stored in device memory or output to the host. Embodiments are not limited to the order of 218, 220, and 222 shown in FIG. 2B. Instead, such steps may be performed in any order, or one or more of the steps may be performed concurrently. Performance may be defined as one or more of transactions or instructions per unit of time (e.g., input/output per second (IOPS)), bandwidth (BW) (e.g., data in/out per second), command latency (e.g., duration), and consistency of command latency (e.g., consistently poor command latency may be preferred by the host).

At 224, it may be determined whether the host queries the device log for power efficiency over time. For example, the controller 106 may detect receipt of a command from the host 102 requesting power efficiency data. If it is determined that the host has not queried the device for power efficiency over time, the methodology returns to 216 where the device captures and stores a detected workload. If it is determined that the host has queried the device for power efficiency over time, the device may perform static reporting of a given set of workloads and power consumption values or an average power consumption over a given time period for the workloads, at 226. For example, the controller 106 may compile historical log data stored in memory into a summary of average power/performance for each workload class. Such static reporting may include generating summaries for specific workloads (e.g., sequential writes at QD16) using previously recorded log data, and sending the summaries to the host. For example, a container-based application management dictated measurement methodology drive may have an average power level per second for a given workload. The static report may be populated at manufacture with a significant number of data points from the device or with a significant number of data points from a validated measurement from one or more approved and representative devices.

The device reporting, and optionally power profiles, may enable vendors to perform power analysis and optimization. Holding all vendors to the same standard may push the industry toward better efficiency.

A host may use power efficiency data to assign different workloads to different drives that have optimized power efficiency for that given workload. For example, static reporting from the device may be used to assign workloads in a predictive manner. As another example, dynamic workload movement may be based on ongoing queries of device and system monitoring.

The ability to standardize and optimize power efficiency may create a more competitive sustainability landscape.

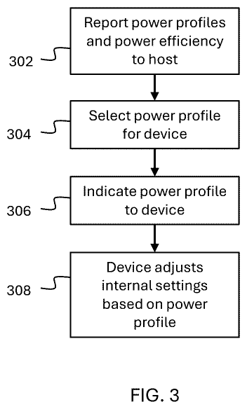

FIG. 3 is a flowchart illustrating a method for power efficiency optimization by a host, according to an embodiment. At 302, a device may report power profiles and power efficiency (e.g., performance/power (watt)) for a given set of workloads to a host. For example, the controller 106 may collect power efficiency metrics and transmit them to the host 102. The report may include a list of profiles associated with different workload types, along with corresponding performance/watt values measured during testing or customer use. The device may transmit this data to the host via standard or specific commands, such as NVMe log pages or telemetry mechanisms. The host may know how each device will be used in the system, and may use this information to optimize power efficiency of the system. Devices may have a set of one or more power profiles, and with this information, the devices may be populated into the correct enclosures that will be used in planned ways. For example, drives that are better at reads may be populated into artificial intelligence (AI) training use cases where reads are emphasized, and drives that are better at mixed workloads may be used in general compute storage or a virtual machine (VM) use cases since the demands may not be predictable in those enclosures.

At 304, once the device is in an enclosure, the host may select an available power profile for the device. For example, the host 102 may evaluate the reported power profiles to select one that optimizes efficiency for a specific workload. The host may make this selection based on actual or expected workload behavior by using historical telemetry or system performance goals. For example, the host may have populated an enclosure with drives emphasizing write efficiency, but there may be a temporary use-case for the enclosure to perform more reads. The host may then choose the power profile that emphasizes read power efficiency for a short duration. Alternatively, the enclosure may be populated for write efficiency, but the host may discover that more reads may occur in the future. The host may then make a change to the drive for it to use the most read power efficient profile moving forward. Accordingly, a power profile for high QD and small reads may be chosen for AI training, a power profile that reads different QDs and sizes may be chosen for AI interference, a power profile for low QD and large reads may be chosen for cold object storage, a power profile for high QD and large sequential writes may be chosen for checkpointing, and a power profile for mixed workloads with QD changes may be chosen for compute direct-attached storage or a VM.

A host may select power profiles for the most power efficient system usage. However, the host may use the power profiles for performance reasons. For example, the host may want to complete an urgent task quickly. The host may then select a profile that is not power efficient in order to complete the work more quickly. Optionally, the completion of the workload may allow the drive to go back to idle sooner, which may be a method of achieving system power efficiency. The host may also be balancing power efficiency across the device, a network interconnect (NIC), a central processing unit (CPU), a graphics processing unit (GPU), and a dynamic random access memory (DRAM), and the host may select a power profile that enables more optimal power for the whole system.

At 306, the host may indicate the selected power profile to the device. The instruction may be sent via firmware control commands or configuration registers. For example, the host 102 may send a profile selection command to the controller 106. The profile ID or descriptor may be communicated along with timing and priority information, allowing the device to apply changes immediately or until an appropriate transition point. At 308, the device may adjust internal hardware settings based on the selected power profile in order to appropriately utilize resources. For example, the controller 106, executing firmware on a processor, may adjust the internal hardware settings. Examples of such adjustments may include adjusting controller or NAND clocks, enabling/disabling ECC levels, changing data compression settings, or limiting background activities like garbage collection. The device may enter a sleep state for that given power profile.

The end-user may also recognize that the workload is going to change and that the types of workloads needed may change (e.g., AI inference vs. AI training), and may then change the power profiles of the device.

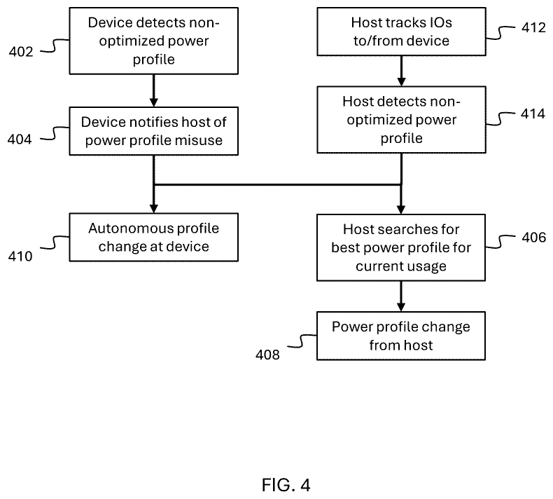

FIG. 4 is a flowchart illustrating a method for determining power profile misuse, according to an embodiment. In a first path for changing the power profile in response to power profile misuse, at 402, a device may detect that it is performing a workload that its power profile is not optimized for. For example, the controller 106 may detect a mismatch between current workload characteristics and its active profile. This detection may be based on internal monitoring of I/O patterns, such as QD, access type (read vs. write), randomness, and data size, compared against the currently active profile's expected workload characteristics. At 404, the device may notify the host of power profile misuse. The notification to the host may include a proposed best power profile for the workload. For example, the controller 106 may transmit a notification of the host 102 identifying a better-suited power profile for the current workload. This notification may be communicated using a specific message or command, and may contain performance and power data justifying the recommendation. At 406, the host may search for a best power profile for the current usage at the device. The host may evaluate available profiles using current and historical telemetry to determine which profile would yield the best power efficiency or performance. For example, the host 102 may evaluate power profiles based on current and historical telemetry from the storage device 104. At 408, a power profile change may be provided from the host to the device based on the best power profile found by the host. This change may involve sending a control command to switch profiles. For example, the host 102 may transmit a control command to the storage device 104 instructing it to switch to a new power profile. As an alternative, after notifying the host of power profile misuse at 404, the device may autonomously enter a new power profile at 410. The autonomous behavior may be enabled or disabled based on a setting configured by the host, and may involve internal logic selecting a new profile based on real-time metrics. For example, the controller 106, upon detecting misuse, may autonomously switch to a more suitable power profile without host 102 intervention, using internal decision logic executed by a processor and stored by a memory.

In a separate path for changing the power profile in response to power profile misuse, at 412, the host may track IOs sent to and from the device and compare IO attributes against device power profiles. For example, the host 102 may monitor I/O commands sent to and received from the storage device 104. This tracking may involve logging command types, sizes, timing, and access patterns over a period of time, and then, matching those characteristics against known workload profiles. At 414, based on the comparisons, the host may determine that the device usage is not conforming to the intended power profile for the workload. For example, the host 102 may determine that the workload pattern does not match the intended use case for the currently active power profile on the storage device 104. In response, the host may search for a best power profile for current device usage, at 406. For example, the host may test several profiles and use the best behaving power profile. This testing may involve applying different profiles over predetermined times and analyzing the resulting power and performance metrics. At 408, the host may adjust the power profile for the device. This process may be repeated at intervals during the lifecycle of the device to adapt to changing workloads or deployment scenarios.

Utilizing comparisons of IO attributes against device power profiles in determining power profile misuse may be beneficial since expectations may change in the future. Alternatively, the characterizations of the enclosure may have been imperfect. The ongoing workload detection and potential power profile changes means that the workload type does not have to be known. Instead, the power profile may be adjusted as the host demands without having to perform enclosure/workload use-case planning.

In searching for a best power profile, a host may not find alignment between any power profile and a current workload, or the workload may not be known or characterized in advance. The host may set an initial power profile, and then query the device for performance/power (watt) over a period of time, which is described above in 208 of FIG. 2. The host may also use logs from the host side on IO behavior sent to the device. The host may then repeat the process for different power profiles, and determine best power profile for use among the monitored power profiles. This looping and testing of the power profiles may be performed iteratively several times throughout the life of a device. The testing of power profiles may also be performed concurrently. For example, if an enclosure has ten drives that all have the same ten power profiles available, the host may set ten different power profiles (e.g., one power profile to each drive) at the same time for a duration. The host may then query the logs of all ten drives to determine which power profile was best over the duration. The best profile may then be dispersed to all of the drives in the enclosure. The host may perform this profile test once per week, for example.

A device may predict future behavior, which may be adaptive from previous usage. The device may learn how it is being used, may predict near future usage, and may adjust settings to optimize for power efficiency. For example, the device may learn that it enters an idle state every x seconds, and may autonomously adjust internal settings for lower power during the idle states. This may result in lower overall energy. As another example, the device may learn it performs writes for x seconds and performs reads for y seconds, and may adjust power profiles accordingly.

End-users may set target power usage per system. These targets may be based on aggressive or optimistic goals, or may be based on maintaining an expected power usage. Monitoring a system for adherence to these goals may include monitoring power consumed per rack, per enclosure, or per device. Racks, enclosures, or specific devices that are exceeding expectations may be monitored. The monitoring may assist in assessing if a device is near end-of-life or whether there is extra traffic from a bug or an attacker. Additionally, workload rebalancing may be performed in a data center.

A power profile may be optimized in many ways. With respect to a power profile for an SSD, NAND handling may be changed by providing program and/or erase with higher voltages. This results in quicker programming, but with an increased raw bit error rate (RBER). Program energy may also be decreased, which saves power by rushing to an idle state. Recovery time and energy on reads may be increased. An amount of NAND background activity for maintaining data integrity (e.g., the number of patrol reads) may be increased due to degradation.

NAND handling may also be changed by providing program and/or erase with lower voltages. This results in slower programming with decreased RBER, and a reduction in patrol reads. Additionally, NAND handling may be changed using a read sense time. A shorter read sense time may increase RBER, while improving latency. A longer read sense time may reduce RBER. NAND handling may further be changed by allowing an ability to cancel a write for any reason. If a trim command is received for a write that already has data in NAND buffers, the SSD may attempt to cancel this write in order to save energy. NAND handling may also be changed by adding data compression on NAND, which may increase command latency. This addition may also reduce total programmed data and consumed power.

Additionally, with respect to the optimization of SSD power profiles, a NAND channel may be changed based on channel speed. A NAND channel may also be changed by placing some/all channels in a low operational/sleep state. If the host is reading from an internal cache, there is no need for channels to be up and running. Also, some low QD workloads do not use all channels and can predict which channels will be used next.

Further, ASIC changes may be used to optimize SSD power profiles. For example, such changes may be implemented through power islands, by turning off excess CPUs, or by lowering the clock. An ASIC may turn on and off data compression in order to save write energy (e.g., reduce programming times (tProgs)). Multiple clock rates may be provided for different cores that perform certain actions.

SSD power profiles may also be optimized using peripherals through DRAM speed changes, DRAM power islands, capacitor charge voltage, disabling power loss protection (PLP), and disabling power management integrated circuit (PMIC) features.

Further, SSD power profile optimization may include peripheral component interconnect express (PCIe) changes including, for example, link speed, link late count, and link/lane idle state usage.

FIG. 5 is a flowchart illustrating a method for recording average performance and power over time, according to an embodiment. FIG. 5 is a detailed description of an exemplary method for capturing power consumption 202 and capturing device performance 204, of FIG. 2, for an SSD. At 502, a non-volatile memory may be formatted. This may involve issuing a secure erase or format unit command to reset the SSD to a baseline condition. For example, the controller 106 may initiate a secure erase or format command to the storage medium 108 to reset the storage device 104. At 504, a precondition may be set for sequential writes for 1×SSD capacity. Specifically, the entire capacity of the SSD may be written sequentially before performing further operations or measurements. This ensures that the SSD is in a known state and is typically used for performance testing or endurance evaluation. Sequential write means that data is written in a continuous, linear order to the SSD, rather than in a random or scattered pattern.

At 506, the SSD's sustained performance and power consumption may be recorded at QD of 1 over a specified period (e.g., five minutes). Specifically, the sustained performance and power consumption may be recorded while writing data sequentially. There is only one write request being processed at a time, with no other requests waiting the queue. This represents a minimal workload. For example, the SSD may record and average sequential write speed of 500 MB/s, and may consume an average of 3 W over the same duration. This data may be recorded internally using firmware counters or externally using monitoring tools at the host.

At 508, the SSD's sustained performance and power consumption may be recorded at QD of 16 over the specified period. Specifically, the sustained performance and power consumption may be recorded while writing data sequentially, and there are 16 simultaneous write requests queued for the SSD. This represents a moderately heavy workload. For example, the SSD may record and average write speed of 2,000 MB/s, and may consume an average of 5 W during the same period.

At 510, the SSD's sustained performance and power consumption may be recorded at QD of 1024 over the specified period. Specifically, the sustained performance and power consumption may be recorded while writing data sequentially, and there are 1024 simultaneous write requests queued for the SSD. This represents a heavy workload. For example, the SSD may record and average write speed of 6,000 MB/s, and may consume an average of 12 W during the same period.

At 512, the SSD's sustained performance and power consumption at QD of 1 may be remeasured. This remeasurement may verify that steady state was achieved. The remeasurement may ensure that device performance and power behavior are not influenced by certain internal conditions such as caching or thermal throttling.

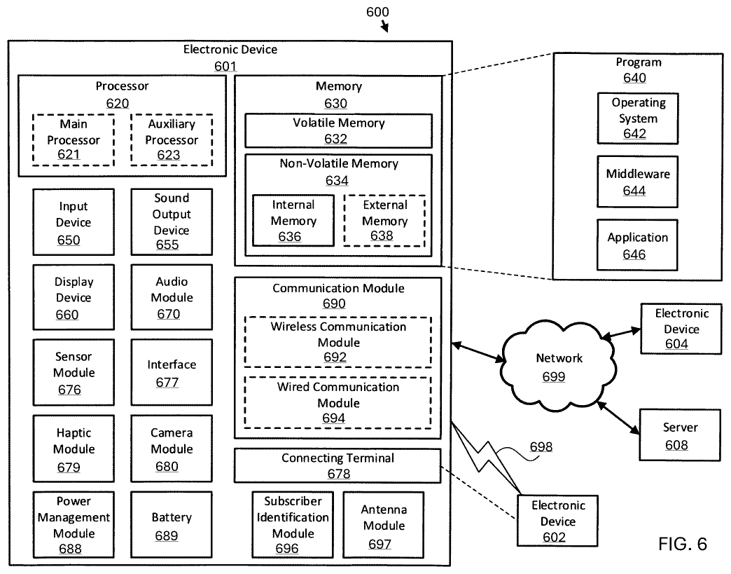

At 514, it may be determined whether the system is testing on writes or reads. If the system is testing on writes, sequential writes is changed to sequential reads, and a precondition is set for sequential reads for 1×SSD capacity, at 516. Specifically, the entire capacity of the SSD may be read sequentially before performing further operations or measurements. The methodology returns to 506, 508, 510, and 512, where an SSD's sustained performance and power consumption may be recorded while reading data sequentially at different QDs (i.e., QD1, QD16, QD1024, QD1). During 506, 508, 510 and 512, the controller 106 may measure device performance and power consumption using internal monitoring logic and store these measurements in memory. In 516, a processor (e.g., processor 620 illustrated in FIG. 6) may be used to validate steady state by comparing consecutive readings.

If it is determined that the system is testing on reads at step 514, it may be determined whether there is an additional command size to be tested at step 518. If there is an additional command size, the methodology returns to 504 to restart the process for sequential writes with the new command size.

If it is determined that there is not an additional command size, a precondition may be set for random writes for 2×SSD capacity at 520. Specifically, random writes may be performed across the SSD for a total amount of data equivalent to twice the capacity of the SSD before conducting further performance tests. This ensures that the SSD is in a steady-state condition, reflecting real-world behavior rather than idealized out-of-the-box performance. Random writes are non-sequential data writes where data is scattered across the SSD. The control logic used in 518-520 may be managed by firmware running on a processor (e.g., processor 620 illustrated in FIG. 6), which sets the state of the SSD prior to performance testing.

At 522, the SSD's sustained performance and power consumption may be recorded at QD of 1 over a specified period (e.g., five minutes). Specifically, the sustained performance and power consumption may be recorded while writing data randomly. There is only one write request being processed at a time, with no other requests waiting the queue. This represents a minimal workload.

At 524, the SSD's sustained performance and power consumption may be recorded at QD of 16 over the specified period. Specifically, the sustained performance and power consumption may be recorded while writing data randomly. There are 16 simultaneous write requests queued for the SSD. This represents a moderately heavy workload.

At 526, the SSD's sustained performance and power consumption may be recorded at QD of 1024 over the specified period. Specifically, the sustained performance and power consumption may be recorded while writing data randomly. There are 1024 simultaneous write requests queued for the SSD. This represents a heavy workload.

At 528, the SSDs sustained performance and power consumption at QD of 1 may be remeasured. Specifically, the sustained performance and power consumption may be recorded while writing data randomly. This remeasurement may verify that steady state was achieved. In other words, this remeasurement ensures that the device has stabilized after handling random data distribution. As before, the controller 106 may issue random writes to the storage medium 108, and a processor (e.g., processor 620 illustrated in FIG. 6) may collect telemetry and storage logs in a memory (e.g., memory 630 illustrated in FIG. 6) or transmit them to the host 102 in 522-528.

At 530, it may be determined whether the system is testing on writes, reads, or a write/read mixed percentage. If the system is testing on writes, random writes is changed to random reads, and a precondition is set for random reads for 2×SSD capacity, at 532. Specifically, random reads may be performed across the SSD for a total amount of data equivalent to twice the capacity of the SSD before conducting further performance tests. The methodology returns to 522, 524, 526, and 528, where the SSD's sustained performance and power consumption may be recorded while reading data randomly at different QDs (i.e., QD1, QD16, QD1024, QD1).

If it is determined that the system is testing on reads or a mixed write/read percentage at step 530, it may be determined whether there is an additional mixed write/read percentage to test at step 534. The additional mixed write/read mix percentages may be one or more of 90/10, 70/30, 50/50, 30/70, or 10/90. If there is an additional mixed write/read mix percentage for testing, a precondition is set for the mixed write/read percentage for 2×SSD capacity at 536. The methodology returns to 522, 524, 526, and 528, where the SSD's sustained performance and power consumption may be recorded while writing/reading data at different QDs (i.e., QD1, QD16, QD1024, QD1).

If it is determined that there is not an additional mixed write/read mix percentage for testing at 534, it may be determined whether there is an additional command size to be tested at step 538. If there is an additional command size, the methodology returns to 520 to restart the process for random writes with the new command size. If there is not an additional command size, the methodology terminates at 540. In 530-538, the controller 106 and processor (e.g., processor 620 illustrated in FIG. 6) may be used to execute a test loop with storage occurring in a memory (e.g., memory 630 illustrated in FIG. 6).

The method for recording average performance and power over time in FIG. 5 may also be based on arrival rate. For example, when one command is arriving every ten seconds, it may be determined whether it is better for the drive to go into an idle state or stay active between commands. The method may also be based on transient workloads that have more complex mixtures of variables such as command type, command size, QD, etc.

Preconditioning is generally intended to ensure that the device is in a steady state (i.e., no longer varying) for its sustained performance. Preconditioning may be achieved through many methods such as by following storage networking steady state recommendations. The drive may be responsible for measuring two back-to-back five minute measurements of the same workload to ensure they are within a threshold of acceptable variation. A remeasure may be required until two consecutive five minute durations report a value with acceptable variations.

A standardized methodology and a standardized file allow for verification of reproducibility. Drive profiles may be used to get a rough comparison of drive A with profile A vs. drive B with profile B used in different deployments in their DC. This is a predictive measure of a drive's sustainability in deployment.

SSD steady state (SS) performance and power may be repeatedly measured for comparisons between vendors (e.g., profile). Constant power under SS workload and performance/power (watt) for each workload may be reported. An SSD may develop several profiles to achieve better performance/power or power/performance under different workloads. For a specific workload, a device may optimize component level settings and modify data access patterns to optimize for power efficiency. A host or computer may use the profiles or a single report to populate systems for optimized power and performance under different workloads expected to be run. There may be a continuous monitoring of power and performance for monitoring expected behaviors from components, for workload balancing, and for changing the device profile (device or host controlled).

A device may have one or more blank fields in a device profile. The one or more blank fields may be used by the host for a future workload that will be defined later. For example, the host may run a test workload and use the log to measure the performance and power of the workload. The host may then load this into a blank field of the device profile to store the performance/power for the new workload.

FIG. 6 is a block diagram of an electronic device in a network environment 600 for processing commands, according to an embodiment. This electronic device may be one of various types of electronic devices that utilizes storage devices described above in FIGS. 1 and 6.

Referring to FIG. 6, an electronic device 601 in a network environment 600 may communicate with an electronic device 602 via a first network 698 (e.g., a short-range wireless communication network), or an electronic device 604 or a server 608 via a second network 699 (e.g., a long-range wireless communication network). The electronic device 601 may communicate with the electronic device 604 via the server 608. The electronic device 601 may include a processor 620, a memory 630, an input device 650, a sound output device 655, a display device 660, an audio module 670, a sensor module 676, an interface 677, a haptic module 679, a camera module 680, a power management module 688, a battery 689, a communication module 690, a subscriber identification module (SIM) card 696, or an antenna module 697. In one embodiment, at least one (e.g., the display device 660 or the camera module 680) of the components may be omitted from the electronic device 601, or one or more other components may be added to the electronic device 601. Some of the components may be implemented as a single integrated circuit (IC). For example, the sensor module 676 (e.g., a fingerprint sensor, an iris sensor, or an illuminance sensor) may be embedded in the display device 660 (e.g., a display).

The processor 620 may execute software (e.g., a program 640) to control at least one other component (e.g., a hardware or a software component) of the electronic device 601 coupled with the processor 620 and may perform various data processing or computations.

As at least part of the data processing or computations, the processor 620 may load a command or data received from a host or another component (e.g., the sensor module 676 or the communication module 690) in volatile memory 632, process the command or the data stored in the volatile memory 632, and store resulting data in non-volatile memory 634. The processor 620 may include a main processor 621 (e.g., a CPU or an application processor (AP)), and an auxiliary processor 623 (e.g., a GPU, an image signal processor (ISP), a sensor hub processor, or a communication processor (CP)) that is operable independently from, or in conjunction with, the main processor 621. Additionally or alternatively, the auxiliary processor 623 may be adapted to consume less power than the main processor 621, or execute a particular function. The auxiliary processor 623 may be implemented as being separate from, or a part of, the main processor 621.

The auxiliary processor 623 may control at least some of the functions or states related to at least one component (e.g., the display device 660, the sensor module 676, or the communication module 690) among the components of the electronic device 601, instead of the main processor 621 while the main processor 621 is in an inactive (e.g., sleep) state, or together with the main processor 621 while the main processor 621 is in an active state (e.g., executing an application). The auxiliary processor 623 (e.g., an image signal processor or a communication processor) may be implemented as part of another component (e.g., the camera module 680 or the communication module 690) functionally related to the auxiliary processor 623.

The memory 630 may store various data used by at least one component (e.g., the processor 620 or the sensor module 676) of the electronic device 601. The various data may include, for example, software (e.g., the program 640) and input data or output data for a command related thereto. The memory 630 may include the volatile memory 632 or the non-volatile memory 634. Non-volatile memory 634 may include internal memory 636 and/or external memory 638. The memory 630 may be embodied as the storage device 104 of FIG. 1.

The program 640 may be stored in the memory 630 as software, and may include, for example, an operating system (OS) 642, middleware 644, or an application 646.

The input device 650 may receive a command or data to be used by another component (e.g., the processor 620) of the electronic device 601, from the outside (e.g., a user) of the electronic device 601. The input device 650 may include, for example, a microphone, a mouse, or a keyboard.

The sound output device 655 may output sound signals to the outside of the electronic device 601. The sound output device 655 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 660 may visually provide information to the outside (e.g., a user) of the electronic device 601. The display device 660 may include, for example, a display, a hologram device, or a projector and control circuitry to control a corresponding one of the display, hologram device, and projector. The display device 660 may include touch circuitry adapted to detect a touch, or sensor circuitry (e.g., a pressure sensor) adapted to measure the intensity of force incurred by the touch.

The audio module 670 may convert a sound into an electrical signal and vice versa. The audio module 670 may obtain the sound via the input device 650 or output the sound via the sound output device 655 or a headphone of an external electronic device 602 directly (e.g., wired) or wirelessly coupled with the electronic device 601.

The sensor module 676 may detect an operational state (e.g., power or temperature) of the electronic device 601 or an environmental state (e.g., a state of a user) external to the electronic device 601, and then generate an electrical signal or data value corresponding to the detected state. The sensor module 676 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 677 may support one or more specified protocols to be used for the electronic device 601 to be coupled with the external electronic device 602 directly (e.g., wired) or wirelessly. The interface 677 may include, for example, a high-definition multimedia interface (HDMI), a universal serial bus (USB) interface, a secure digital (SD) card interface, or an audio interface.

A connecting terminal 678 may include a connector via which the electronic device 601 may be physically connected with the external electronic device 602. The connecting terminal 678 may include, for example, an HDMI connector, a USB connector, an SD card connector, or an audio connector (e.g., a headphone connector).

The haptic module 679 may convert an electrical signal into a mechanical stimulus (e.g., a vibration or a movement) or an electrical stimulus which may be recognized by a user via tactile sensation or kinesthetic sensation. The haptic module 679 may include, for example, a motor, a piezoelectric element, or an electrical stimulator.

The camera module 680 may capture a still image or moving images. The camera module 680 may include one or more lenses, image sensors, image signal processors, or flashes. The power management module 688 may manage power supplied to the electronic device 601. The power management module 688 may be implemented as at least part of, for example, a power management integrated circuit (PMIC).

The battery 689 may supply power to at least one component of the electronic device 601. The battery 689 may include, for example, a primary cell which is not rechargeable, a secondary cell which is rechargeable, or a fuel cell.

The communication module 690 may support establishing a direct (e.g., wired) communication channel or a wireless communication channel between the electronic device 601 and the external electronic device (e.g., the electronic device 602, the electronic device 604, or the server 608) and performing communication via the established communication channel. The communication module 690 may include one or more communication processors that are operable independently from the processor 620 (e.g., the AP) and supports a direct (e.g., wired) communication or a wireless communication. The communication module 690 may include a wireless communication module 692 (e.g., a cellular communication module, a short-range wireless communication module, or a global navigation satellite system (GNSS) communication module) or a wired communication module 694 (e.g., a local area network (LAN) communication module or a power line communication (PLC) module). A corresponding one of these communication modules may communicate with the external electronic device via the first network 698 (e.g., a short-range communication network, such as BLUETOOTH™, wireless-fidelity (Wi-Fi) direct, or a standard of the Infrared Data Association (IrDA)) or the second network 699 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 692 may identify and authenticate the electronic device 601 in a communication network, such as the first network 698 or the second network 699, using subscriber information (e.g., international mobile subscriber identity (IMSI)) stored in the subscriber identification module 696.

The antenna module 697 may transmit or receive a signal or power to or from the outside (e.g., the external electronic device) of the electronic device 601. The antenna module 697 may include one or more antennas, and, therefrom, at least one antenna appropriate for a communication scheme used in the communication network, such as the first network 698 or the second network 699, may be selected, for example, by the communication module 690 (e.g., the wireless communication module 692). The signal or the power may then be transmitted or received between the communication module 690 and the external electronic device via the selected at least one antenna.

Commands or data may be transmitted or received between the electronic device 601 and the external electronic device 604 via the server 608 coupled with the second network 699. Each of the electronic devices 602 and 604 may be a device of a same type as, or a different type, from the electronic device 601. All or some of operations to be executed at the electronic device 601 may be executed at one or more of the external electronic devices 602, 604, or 608. For example, if the electronic device 601 should perform a function or a service automatically, or in response to a request from a user or another device, the electronic device 601, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 601. The electronic device 601 may provide the outcome, with or without further processing of the outcome, as at least part of a reply to the request. To that end, a cloud computing, distributed computing, or client-server computing technology may be used, for example.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

Although certain embodiments of the present disclosure have been described in the detailed description of the present disclosure, the present disclosure may be modified in various forms without departing from the scope of the present disclosure. Thus, the scope of the present disclosure shall not be determined merely based on the described embodiments, but rather determined based on the accompanying claims and equivalents thereto.

What is claimed is:

1. A method comprising:
capturing, by a device, power consumption and device performance for a workload at the device;
determining, by the device, power efficiency for the workload based on the power consumption and the device performance; and
reporting, by the device, the power efficiency for the workload to a host.

2. The method of claim 1, further comprising:
logging, by the device, power efficiency over time; and
reporting, from the device, to the host, power consumption values or an average power consumption over a time period for the workload.

3. The method of claim 1, further comprising:
transmitting power profiles from the device to the host, wherein the power profiles comprise internal settings of the device that increase power efficiency for different workload scenarios.

4. The method of claim 3, further comprising:
receiving, at the device, from the host, a power profile selected by the host from the power profiles; and
adjusting, by the device, the internal settings for resource utilization at the device based on the selected power profile.

5. The method of claim 1, further comprising:
receiving, at the device, from the host, workloads assigned by the host based on the reported power efficiency.

6. The method of claim 1, further comprising:
determining, by the device, that a current power profile of the device has deficient power efficiency for the workload;
providing, from the device, to the host, a notification of the deficient power efficiency for the workload.

7. The method of claim 6, further comprising:
selecting, by the device, a new power profile for the device that increases power efficiency for the workload; and
autonomously entering the new power profile at the device.

8. The method of claim 6, further comprising:
selecting, by the device, a new power profile for the device that increases power efficiency for the workload; and
reporting the new power profile from the device to the host.

9. The method of claim 1, further comprising:
adjusting, by the device, internal settings of the device to increase power efficiency based on previous usage patterns at the device.

10. A method comprising:
receiving, by a host, power efficiency for a workload at a device, from the device, wherein the power efficiency is based on power consumption and device steady state performance;
determining, by the host, that the power efficiency is deficient for the workload; and
transmitting, from the host, to the device, an update to the device that increases power efficiency at the device.

11. The method of claim 10, further comprising:
receiving, by the host, from the device, power consumption values or an average power consumption over a time period for the workload.

12. The method of claim 10, further comprising:
receiving, by the host, power profiles of the device from the device, wherein the power profiles comprise internal settings of the device that increase power efficiency for different workload scenarios.

13. The method of claim 12, further comprising:
selecting, by the host, a power profile, from the power profiles, that increases power efficiency for the workload at the device,
wherein transmitting the update comprises transmitting the selected power profile, from the host, to the device, and
wherein the device adjusts the internal settings for resource utilization at the device based on the selected power profile.

14. The method of claim 13, wherein selecting the power profile comprises:
setting an initial power profile, from the power profiles;
monitoring power efficiency at the device based on the initial power profile;
repeating the setting and monitoring for one or more other profiles, from the power profiles, wherein the selected power profile has a highest power efficiency for the workload among the monitored power profiles.

15. The method of claim 10, further comprising:
selecting, by the host, workloads for the device based on the power efficiency for the workload,
wherein transmitting the update comprises transmitting the selected workloads from the host, to the device.

16. The method of claim 10, further comprising:
receiving, by the host, from the device, a notification of deficient power efficiency for the workload at the device.

17. The method of claim 16, further comprising:
receiving, by the host, a new power profile from the device, wherein the new power profile increases power efficiency for the workload at the device.

18. An electronic device comprising:
a processor; and
a non-transitory computer readable storage medium storing instructions that, when executed, cause the processor to:
capturing power consumption and performance for a workload;
determine power efficiency for the workload based on the power consumption and the performance; and
report the power efficiency for the workload to a host.

19. The electronic device of claim 18, wherein the instructions further cause the processor to log power efficiency over time and report power consumption values or an average power consumption over a time period for the workload.

20. The electronic device of claim 18, wherein the instructions further cause the processor to adjust internal settings to increase power efficiency based on previous usage patterns.
